(19) United States
(12) Patent Application Publication
(10) Pub. No.: US 2025/0212161 A1
(43) Pub. Date: Jun. 26, 2025

(54) MULTI-MODAL FUSION CAPABILITY DISCOVERY

(71) Applicant: Cisco Technology, Inc., San Jose, CA (US)

(72) Inventors: Alan W. DUMDEI, Greenville, TX (US); Malcolm M. SMITH, Richardson, TX (US); Matthew A. SILVERMAN, Shaker Heights, OH (US); Jerome HENRY, Pittsboro, NC (US); Peiman AMINI, Fremont, CA (US); Ardalan ALIZADEH, Campbell, CA (US)

(21) Appl. No.: 18/979,291

(22) Filed: Dec. 12, 2024

Related U.S. Application Data
(60) Provisional application No. 63/613,722, filed on Dec. 21, 2023.

(51) Int. Cl. H04W 64/00; H04W 8/22; H04W 84/12

(52) U.S. Cl. CPC H04W 64/00; H04W 8/22; H04W 84/12

(57) ABSTRACT

An approach for performing discovery of capacity to perform multiple wireless location techniques includes a wireless access point that is capable of performing a first set of wireless location techniques transmitting a beacon message indicating this fact. A client device receives the beacon message and transmits a reply message listing a second set of wireless location techniques that the client device is capable of performing. The wireless access point and the client device may thereafter cooperate to determine the location of the client device relative to the access point using two or more wireless location techniques that are in the first and second sets. Other information, such as channels, bands, and bandwidth available for use in location determination may be shared between the wireless access point and the client device.

### CROSS-REFERENCE TO RELATED APPLICATIONS

This application claims benefit of co-pending U.S. provisional patent application Ser. No. 63/613,722 filed Dec. 21, 2023. The aforementioned related patent application is herein incorporated by reference in its entirety.

### TECHNICAL FIELD

Embodiments presented in this disclosure generally relate to wireless access points. More specifically, embodiments disclosed herein relate to approaches for determining the location of a client device relative to an access point.

### BACKGROUND

Wireless communication protocols include the Institute of Electrical and Electronics Engineers (IEEE) 801.11 family of standards, also known as WI-FI, and the IEEE 802.15.1 standard, also known as BLUETOOTH. Some devices that implement these standards implement beam forming in which a directional antenna directs radio signals in a beam toward a client device in order to conserve energy and more efficiently use available bandwidth in the electromagnetic spectrum. Effective beam forming depends on the accuracy of estimates of the location of the client device. Other aspects of these protocols make use of a range to a client device.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a block diagram of a network system, according to one embodiment described herein.

FIG. 2 is a block diagram of an Access Point, according to one embodiment.

FIG. 3 is a process flow diagram of a method for communicating capability to perform multiple locating techniques, according to one embodiment.

FIG. 4 is a process flow diagram of a method for performing discovery of capability of a client device to perform multiple locating techniques, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure includes a method that includes transmitting, by a wireless access point, a beacon message indicating capability of the wireless access point to perform location determination using a first set of different wireless location techniques. The wireless access point receives, from a client device, a reply message in response to the beacon message. The wireless access point determines (a) that the reply message indicates capability of the client device to perform location determination using a second set of different wireless location techniques. In response to (a), the wireless access point cooperates with the client device to determine a location of the client device using two or more different wireless location techniques that are in both the first and second sets.

In another embodiment, a wireless access point includes one or more wireless transceivers, one or more processing devices, and one or more memory devices operably coupled to the one or more processing devices. The one or more memory devices store executable code that, when executed by the one or more processing devices, causes the one or more processing devices to perform an operation. The operation includes transmitting, using the one or more wireless transceivers, a beacon message indicating capability of the wireless access point to perform location determination using a first set of different wireless location techniques. The operation includes receiving, from a client device, a reply message in response to the beacon message. The operation includes determining (a) that the reply message indicates capability of the client device to perform location determination using a second set of different wireless location techniques. In response to (a), the operation includes cooperating with the client device to determine a location of the client device using two or more different wireless location techniques that are in both the first and second sets.

In yet another embodiment, a non-transitory computer-readable medium stores executable code that, when executed by one or more processing devices, causes the one or more processing devices to perform an operation. The operation includes transmitting, using one or more wireless transceivers, a beacon message indicating capability of a wireless access point to perform location determination using a first set of different wireless location techniques. The operation further includes receiving, from a client device, a reply message in response to the beacon message and determining (a) that the reply message indicates capability of the client device to perform location determination using a second set of different wireless location techniques. The operation further includes, in response to (a), cooperating with the client device to determine a location of the client device using two or more different wireless location techniques that are in both the first and second sets.

### EXAMPLE EMBODIMENTS

The location of a client device relative to a wireless access point may be more accurately determined using multiple wireless location techniques. However, not all client devices are capable of doing so. Likewise, a client device may be capable of using multiple wireless location techniques whereas a wireless access point is not.

In the approach described below, messages used to establish a wireless connection according to a wireless protocol are modified to communicate capability of the client and/or access point to use multiple wireless location techniques. For example, for a WI-FI connection, a beacon message broadcast by a wireless access point may include an indicator (e.g., a bit value) indicating that the wireless access point is capable of using multiple wireless location techniques. A client device can detect that bit and include an information element in a probe request, the information element listing the wireless location techniques that the client device is capable of performing. The access point receives the information element and, in response, transmits a probe response likewise listing the wireless location techniques that the access point is capable of performing. Thereafter, the access point and the client device may use wireless location techniques that they have in common to determine the relative location of the client device.

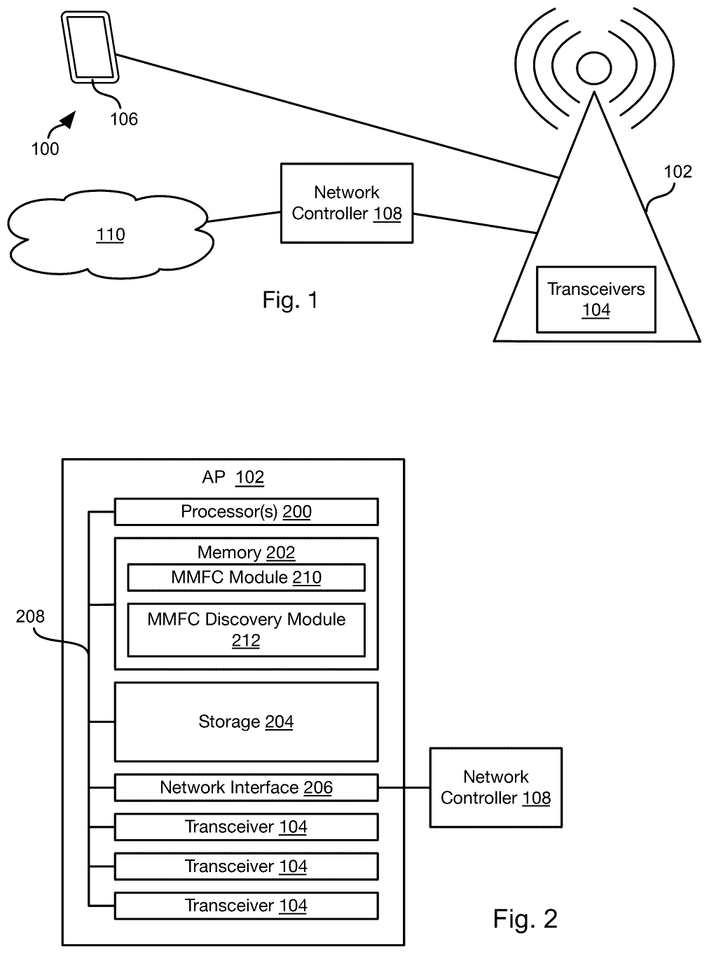

Referring to FIG. 1, a network environment 100 may include an access point (AP) 102 including one or more wireless transceivers 104. The transceivers 104 may include antennas and corresponding circuits for sending and receiving wireless signals. Where there are multiple transceivers 104, each transceiver 104 may be configured for a particular wireless communication protocol and corresponding frequency range. For example, the transceivers 104 may be configured for use according to one or more of the BLUETOOTH, BLUETOOTH low energy (BLE), WI-FI, ultra-wideband (UWB), or other protocol. The same transceiver 104 may be used to send and receive signals according to multiple protocols, or for only one protocol.

A user computing device 106 may wirelessly communicate with the access point 102 by way of one or more of the transceivers 104 and according to one or more wireless protocols, such as any of those listed above. The user computing device 106 may be a mobile phone, tablet computer, wearable computer, laptop computer, or any other type of computing device. The user computing device 106 operates as a client device with respect to the access point 102 in the approach described below.

The user computing device 106 may communicate with a network controller 108 by way of the access point 102. The network controller 108 may be configured to manage network communication with a network 110, such as a local area network (LAN), wide area network (WAN), the Internet, or any other type of network.

The location of the user computing device 106 relative to the transceivers 104 may be determined for purposes of performing beam forming, to obtain location information for use by applications executing on the user computing device 106, or for other purposes. In some implementations, the user computing device 106 may wirelessly communicate with multiple transceivers 104 according to the same protocol, such as for determining a location of the user computing device relative to the access point 102.

As discussed in greater detail below, the accuracy of a location estimate may be enhanced by using a combination of multiple wireless location techniques, referred to herein as multi-modal fusion capabilities (MMFC). Using the approach described below, the access point 102 and user computing device 106 discover one another's ability to use multiple wireless location techniques and the identities of these techniques.

Examples of wireless location techniques as used herein below may include any of those listed in Table 1, below. As is apparent in Table 1, some techniques may be implemented using a particular wireless protocol (e.g., UWB, BLUETOOTH, BLE, WI-FI).

TABLE 1
Wireless Location Techniques

| Protocol | Location Technique |
|---|---|
| UWB | Dual receiver maximum ratio combining (dual Rx/MRC) |
| UWB | Phase difference of arrival (PDOA) |
| UWB | Time difference of arrival (TDOA) |
| UWB | Single-sided two-way ranging (SS-TWR) |
| UWB | Double-sided two-way ranging (SS-TWR) |
| UWB | Automatic gain control (AGC) (use AGC related guard |
| | time requirements to estimate location) |
| BLE | High accuracy distance measurement (HADM) (a phase- |
| | based ranging (PBR) and round-trip time (RTT) approach) |
| BLE | High accuracy indoor positioning (HAIP) (an angle of |
| | arrival (AoA) approach) |
| BLE | Received signal strength indicator (RSSI) |
| WI-FI | Fine timing measurement (FTM) |
| WI-FI | WI-FI positioning system (determine location from multiple |
| | access points based on RSSI) |
| WI-FI | Channel state information (CSI) use |
| Any | Clock sharing (Use precision of synchronized and/or shared |
| | clocks between clock domains and radios to estimate location) |

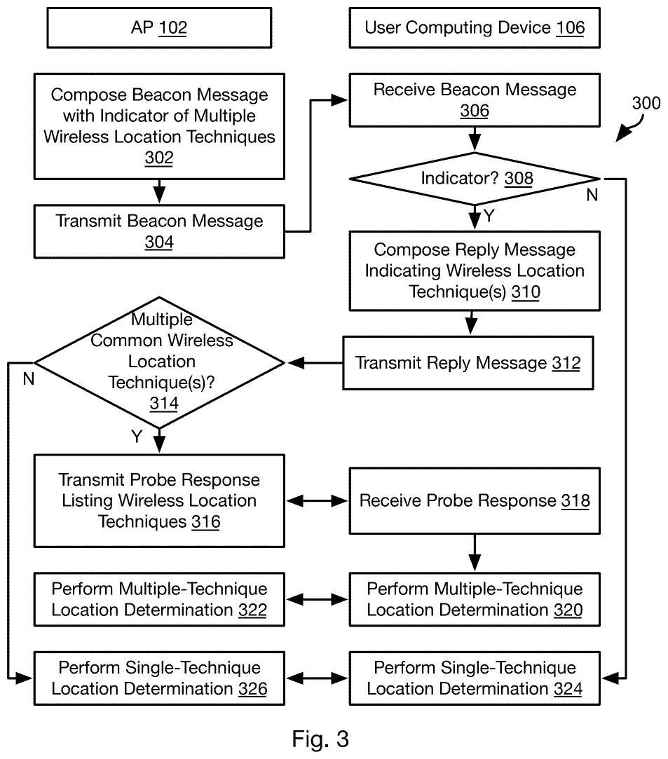

FIG. 2 is a block diagram of an example access point 102, according to one embodiment. The access point 102 may be configured to execute the methods described herein, such as the method 300 of FIG. 3, described below. The access point 102 is shown in the form of a general-purpose computing device, but may include a server and/or application executing on a cloud network. The components of access point 102 may include, but are not limited to, one or more processing units or processors 200, a system memory 202, a storage system 204, network interface 206 connecting the access point 102 to network controller 108 and external networks 110, transceivers 104, and a bus 208 that couples various system components including the system memory 202 and storage system 204 to processors 200 along with various input/output components (not shown). In other embodiments, the illustrated components of the access point 102 are distributed and includes a plurality of discrete computing devices that are connected through wired or wireless networking.

Bus 208 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The access point 102 may include a variety of computer system readable media (e.g., a non-transitory computer-readable storage medium). Such media may be any available media that is accessible by access point 102, and it includes both volatile and non-volatile media, removable and non-removable media.

System memory 202 can include computer system readable media in the form of volatile memory, such as random access memory (RAM) and/or cache memory. Access point 102 may further include other removable/non-removable, volatile/non-volatile computer system storage media. By way of example, storage system 204 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a Compact Disc Read-Only Memory (CD-ROM), digital versatile disc-read only memory (DVD-ROM) or other optical media can be provided. In such instances, each can be connected to bus 208 by one or more data media interfaces. As will be further depicted and described below, system memory 202 may include at least one program product having a set (e.g., at least one) of program modules that are configured to carry out the functions of various embodiments described herein.

Access point 102 may further include other removable/non-removable, volatile/non-volatile computer system storage media. In some examples, storage system 204 may be included as part of system memory 202 and may typically provide a non-volatile memory for the networked computing devices, and may include one or more different storage elements such as Flash memory, a hard disk drive, a solid state drive, an optical storage device, and/or a magnetic storage device. For example, storage system 204 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 208 by one or more data media interfaces.

System memory 202 may store a plurality of modules 210, 212 for performing various functions described herein. The modules 210, 212 generally include program code that is executable by one or more of the processors 200. As shown, modules 210, 212 may include a multi-modal fusion capability (MMFC) module 210 and a MMFC discovery module 212.

The MMFC module 210 may use location determinations using multiple techniques (see Table 1) to obtain a more accurate estimate of the relative location of a the user computing device 106 relative to each technique individually. The MMFC module 210 may correlate location determinations according to different techniques to the same user computing device 106 to facilitate combination of the location determinations. The MMFC module 210 may average location determinations according to the multiple techniques, process the location determinations over time using a filter, such as a Kalman filter, process the location determinations using a machine learning model, or some other approach. Some techniques may be accurate in different ranges. Accordingly, the MMFC module 210 may perform a weighted average of location techniques with the weight applied to a location determination by a technique being a function of a distance to the user computing device 106 determined using that technique.

The MMFC discovery module 212 may be used to discover the capacity of a user computing device to perform location determination using multiple location techniques. For example, the MMFC discovery module 212 may execute the portion of the method 300 ascribed to the access point 102 in the description below.

Referring to FIG. 3, the illustrated method 300 may be performed by the access point 102 and the user computing device 106, such as by the MMFC discovery module 212 and a wireless controller of the user computing device 106.

The access point 102 may compose, at block 302, a beacon message. The beacon message may be a beacon according to any wireless protocol, such as WI-FI, BLE, UWB, or the like. For example, the beacon message may include the basic service set identifier (BSSID) of the access point 102. The beacon message may be modified relative to prior approaches to include an indicator that communicates that the access point 102 is capable of using multiple wireless location techniques (e.g., is MMFC capable). For example, the indicator may be implemented using a bit position in the beacon message which may be set (e.g., to 1) to indicate capacity to use multiple wireless location techniques. For example, some bits according to the wireless protocol used may be unused (e.g., reserved) and/or available for custom definition by an access point 102. For example, the beacon message may include an extended capabilities table and a bit of this table may be assigned for use as the indicator, e.g., bit 103 in some embodiments according to the WI-FI protocol.

Other contents of the beacon message may be selected based on properties of the access point 102 according to any approach known in the art for the wireless protocol used.

The access point 102 transmits the beacon message at block 304. The beacon message may be broadcast to any device within range of the access point 102 as opposed to being addressed to a particular user computing device.

The user computing device 106 receives the beacon message at block 306. In response to receiving the beacon message, the user computing device 106 may evaluate, at block 308, whether the beacon message indicates that the access point 102 is capable of using multiple wireless location techniques. If so, the user computing device 106 may compose, at block 310, a reply message (e.g., a probe request according to the WI-FI protocol) that indicates that the user computing device 106 is capable of using multiple wireless location techniques. The reply message may further list which multiple wireless location techniques the user computing device 106 is capable of using (e.g., any of those listed in Table 1) and possibly one or more attributes defining one or more of these wireless location techniques. In some embodiments, the user computing device 106 is configured to map each bit of a field in the reply message to a specific wireless location technique. The user computing device 106 may therefore set a bit position in that field (e.g., to 1) to indicate that the user computing device 106 is capable of participating in the wireless location technique corresponding to that bit position.

For example, the reply message may include an information element indicating which of the wireless location techniques are supported by the user computing device 106, e.g., codes corresponding to any of those listed in Table 1 or any other wireless location technique. In some embodiments, the information element may further list which multi-modal channels the user computing device 106 can support for each of the listed wireless location techniques. The information element may be dedicated to communicating the wireless location techniques or may be another information element that also communicates other information according to the wireless protocol used, such as WI-FI.

For example, a first field may be included with each bit position, when set (e.g., to 1) indicating that the user computing device 106 supports use of a channel corresponding to that position. A second field may be included, with each bit position, when set (e.g., to 1) indicating that the user computing device 106 supports use of a frequency band corresponding to that position. A third field may be included with the value of the third field indicating a supported bandwidth, e.g., a number of predefined bandwidth increments. Information regarding channels, bands, and bandwidth may be used to assess the accuracy that can be obtained using a wireless location technique, e.g., more channels, bands, and bandwidth correspond to greater potential accuracy.

In one specific example, the first field is an eight-bit field, the second field is a 3×8 bit field (1 field per band), and the third field is a 3×8 bit field and the bandwidth increment is 20 MHz (e.g., a value of 8 corresponds to a bandwidth of 160 MHz and a value of 25 corresponds to a bandwidth of 500 MHZ).

The user computing device transmits, at block 312, the reply message to the access point 102. The access point 102 evaluates the reply message at block 314. If the reply message indicates that the user computing device 106 is capable of using multiple wireless location techniques, the access point 102 transmits, at block 316, a response, such as a probe response according to the WI-FI protocol. The probe response may list wireless location techniques that the access point 102 is capable of performing. The probe response may include some or all of the information described above with respect to block 310 listing the wireless location techniques and possibly any other items of information listed above at block 310. In some embodiments, the access point 102 is configured to map each bit of a field in the probe response to a specific wireless location technique. The access point 102 may therefore set a bit position in that field (e.g., to 1) to indicate that the user computing device 106 is capable of participating in the wireless location technique corresponding to that bit position. In some embodiments, the access point 102 may list only those wireless location techniques both of (a) the access point 102 is capable of performing and (b) were listed by the user computing device 106 in the reply message. The beacon message is typically a very short message with limited capacity to communicate information. However, in some embodiments, the beacon message may include the listing of wireless location techniques of the access point 102 such that the listing is not included in the probe response.

The user computing device 106 may then receive, at block 318, the response from the access point 102, e.g., the probe response. The user computing device 106 and access point 102 may then cooperate to perform, at blocks 320 and 322, location determination using multiple wireless location techniques. Specifically, those wireless techniques that are common between those listed in the reply message and in the probe response may be used to determine the location of the user computing device 106 relative to the access point 102. Likewise, location determination may be used using channels, bands, and bandwidths common to the user computing device 106 and access point 102. Blocks 324 and 326 may include implementing the functionality of the MMFC module 210 as described above.

For example, the access point 102 may support location determination using UWB using channel C1 and bands B1 and B2 with bandwidth BW1 and using channels C2 and bands B3 and B4 with bandwidth BW2. The access point 102 may further support location determination using WI-FI. The user computing device 106 may support location determination using UWB with channel C1 and band B2 with bandwidth BW3. The user computing device 106 may further support location determination using WI-FI. Accordingly, the access point 102 and user computing device 106 may cooperate to perform wireless location determination using WI-FI and UWB with channel C1 and band B2 with the smaller of bandwidths BW1 and BW3.

In some scenarios, the user computing device 106 is capable of using multiple wireless location techniques but the access point 102 from which the user computing device 106 receives a beacon message is not capable. Accordingly, the evaluation of block 308 will find an absence of the indicator as described above with respect to block 302. In such scenarios, the user computing device 106 likewise precedes to block 324, which may include sending a reply message (e.g., probe request) that may lack a listing of multiple wireless location techniques, receive a probe response from the access point 102 that likewise lacks a listing of multiple wireless location techniques, and either omit any location determination or cooperate with the access point 102 to perform location determination using a single wireless location technique from Table 1 or some other location technique.

In some scenarios, the user computing device 106 is not capable of using multiple wireless location techniques. In particular, the user computing device 106 may not be configured to recognize the indicator added to the beacon message at block 302. Accordingly, any reply message (e.g., probe request) from such a user computing device 106 will not be found to indicate multiple wireless location techniques at block 314, since the user computing device 106 is not configured to include such information in response to the indicator. In such scenarios, the access point 102 will proceed to block 326, which includes sending a probe response that may lack an information element listing multiple wireless location techniques and either omitting location determination or performing single-technique location determination according to any of the approaches of Table 1 or some other location technique.

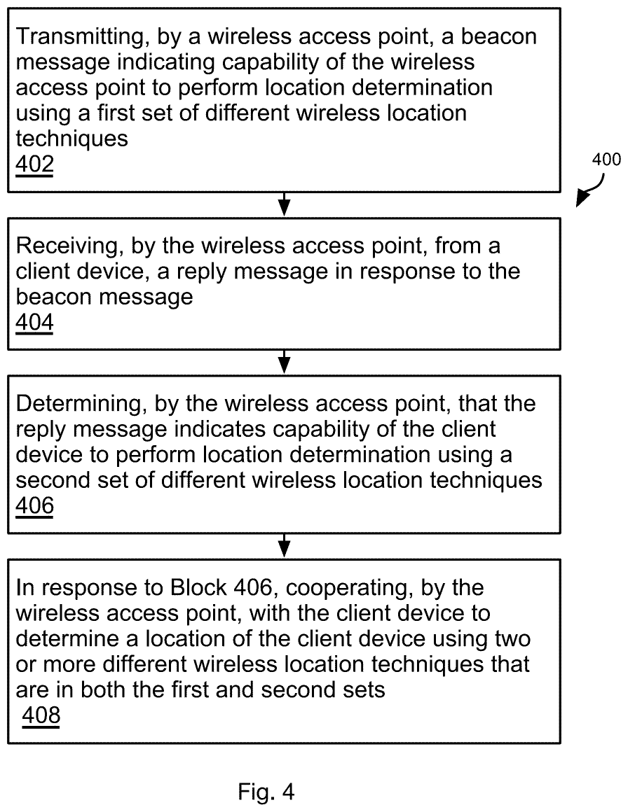

FIG. 4 illustrates an example method 400 that may be performed by, for example, a the access point 102 acting as a wireless access point and the user computing device 106 acting as a client device.

The method 400 may include transmitting, at block 402, by the wireless access point, a beacon message indicating capability of the wireless access point to perform location determination using a first set of different wireless location techniques. For example, block 402 may include transmitting a beacon message according to WI-FI protocol with a bit set to indicate capability of the access point 102 to perform multiple wireless location techniques.

The method 400 may include receiving, at block 404, by the wireless access point, from a client device, a reply message in response to the beacon message. For example, the reply message may be a probe request transmitted by the user computing device 106 according to the WI-FI protocol.

The method 400 may include determining, at block 406, by the wireless access point, that the reply message indicates capability of the client device to perform location determination using a second set of different wireless location techniques. For example, the reply message may list one or more wireless location techniques from Table 1 or other wireless location techniques. The reply message may further provide parameters for performing wireless location techniques, such as channels, bands, and/or bandwidth available for performing location determination.

The method 400 may include, in response to determining that the reply message indicates capability of the client device to perform location determination using the second set of different wireless location techniques at block 406, cooperating, at block 408, by the wireless access point, with the client device, to determine a location of the client device using two or more different wireless location techniques that are in both the first and second sets. For example, block 408 may include performing location determination by the access point 102 and user computing device 106 using any of the wireless location techniques of Table 1 that are common in the first and second set. Block 408 may include performing location determination using channels, bands, and/or bandwidth that are common to the access point 102 and the user computing device 106.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
transmitting, by a wireless access point, a beacon message indicating capability of the wireless access point to perform location determination using a first set of different wireless location techniques;
receiving, by the wireless access point, from a client device, a reply message in response to the beacon message;
(a) determining, by the wireless access point, that the reply message indicates capability of the client device to perform location determination using a second set of different wireless location techniques; and
in response to (a), cooperating, by the wireless access point, with the client device to determine a location of the client device using two or more different wireless location techniques that are in both the first and second sets.

2. The method of claim 1, wherein the beacon message is a beacon frame according to Institute of Electrical and Electronics Engineers (IEEE) 802.11 Protocol.

3. The method of claim 2, wherein the reply message is a probe request according to IEEE 802.11 Protocol.

4. The method of claim 3, wherein the reply message includes an information element (IE) indicating the capability of the client device to perform location determination using the first set.

5. The method of claim 1, wherein the reply message further indicates an available bandwidth for implementing the second set.

6. The method of claim 1, further comprising transmitting, in response to (a), by the wireless access point, to the client device, a response including a listing of the first set.

7. The method of claim 1, wherein the first set of different wireless location techniques includes a plurality of wireless protocols.

8. The method of claim 7, wherein the plurality of wireless protocols include two or more of: IEEE 802.11 Protocol, BLUETOOTH low energy (BLE) protocol, Ultra-Wideband (UWB), and a clock sharing protocol.

9. The method of claim 7, wherein the plurality of wireless protocols include UWB and the first set includes dual receiver maximum ratio combining (dual Rx/MRC), phase difference of arrival (PDOA), time difference of arrival (TDOA), single-sided two way ranging (SS-TWR), double-sided two-way ranging (DS-TWR), automatic gain control and (AGC) use.

10. The method of claim 7, wherein the plurality of wireless protocols include BLE and the first set includes high accuracy distance measurement (HADM), high accuracy indoor positioning (HAIP), and received signal strength indicator (RSSI) use.

11. The method of claim 7, wherein the plurality of wireless protocols include IEEE 802.11 Protocol and the first set includes fine timing measurement (FTM), WI-FI positioning system, and channel state information (CSI) use.

12. A wireless access point comprising:
one or more wireless transceivers;
one or more processing devices; and
one or more memory devices operably coupled to the one or more processing devices, the one or more memory devices storing executable code that, when executed by the one or more processing devices, causes the one or more processing devices to perform an operation, the operation comprising:
transmitting, using the one or more wireless transceivers, a beacon message indicating capability of the wireless access point to perform location determination using a first set of different wireless location techniques;
receiving, from a client device, a reply message in response to the beacon message;
(a) determining that the reply message indicates capability of the client device to perform location determination using a second set of different wireless location techniques; and
in response to (a), cooperating with the client device to determine a location of the client device using two or more different wireless location techniques that are in both the first and second sets.

13. The wireless access point of claim 12, wherein the beacon message is a beacon frame according to Institute of Electrical and Electronics Engineers (IEEE) 802.11 Protocol and the reply message is a probe request according to IEEE 802.11 Protocol.

14. The wireless access point of claim 13, wherein the reply message includes an information element (IE) indicating the capability of the client device to perform location determination using the first set.

15. The wireless access point of claim 12, wherein the executable code, when executed by the one or more processing devices, further causes the one or more processing devices to, in response to (a), transmit, to the client device, a response including a listing of the first set.

16. The wireless access point of claim 12, wherein the first set of different wireless location techniques includes a plurality of wireless protocols including two or more of: IEEE 802.11 Protocol, BLUETOOTH low energy (BLE) protocol, Ultra-Wideband (UWB), and a clock sharing protocol.

17. The wireless access point of claim 16, wherein the plurality of wireless protocols include UWB and the first set includes dual receiver maximum ratio combining (dual Rx/MRC), phase difference of arrival (PDOA), time difference of arrival (TDOA), single-sided two way ranging (SS-TWR), double-sided two-way ranging (DS-TWR), automatic gain control and (AGC) use.

18. The wireless access point of claim 16, wherein the plurality of wireless protocols include BLE and the first set includes high accuracy distance measurement (HADM), high accuracy indoor positioning (HAIP), and received signal strength indicator (RSSI) use.

19. The wireless access point of claim 16, wherein the plurality of wireless protocols include IEEE 802.11 Protocol and the first set includes fine timing measurement (FTM), WI-FI positioning system, and channel state information (CSI) use.

20. A non-transitory computer-readable medium storing executable code that, when executed by one or more processing devices, causes the one or more processing devices to perform an operation, the operation comprising:
transmitting, using one or more wireless transceivers, a beacon message indicating capability of a wireless access point to perform location determination using a first set of different wireless location techniques;
receiving, from a client device, a reply message in response to the beacon message;
(a) determining that the reply message indicates capability of the client device to perform location determination using a second set of different wireless location techniques; and
in response to (a), cooperating with the client device to determine a location of the client device using two or more different wireless location techniques that are in both the first and second sets.
